(19) United States
(12) Patent Application Publication
(10) Pub. No.: US 2006/0272907 A1
(43) Pub. Date: Dec. 7, 2006

(54) Brake disc fastenable to a wheel hub

(75) Inventors: Wlodzimierz Macke, Olching (DE); Thomas Lipp, Eichenau (DE); Markus Gruber, Steinhoering (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 11/398,611

(22) Filed: Apr. 6, 2006

Related U.S. Application Data
(63) Continuation of application No. PCT/EP04/11098, filed on Oct. 5, 2004.

(30) Foreign Application Priority Data
Oct. 6, 2003 (DE) 103 46 343.7

(51) Int. Cl. F16D 65/12

(52) U.S. Cl. 188/218 XL; 188/17

(57) ABSTRACT

A brake disc for a disc brake is provided, which can be fixed to a wheel hub, especially of a utility vehicle. The brake disc includes two concentric friction rings and a brake disc neck that is connected thereto and is joined to the wheel hub. The disc brake is embodied such that the brake disc neck is fastened to the wheel hub by way of a joining piece, which is connected in a fixed manner to the brake disc neck and be elastically deformed relative to the friction rings in an axial direction.

### CROSS-REFERENCE TO RELATED APPLICATIONS

This application is a continuation of PCT Application No. PCT/EP2004/011098 filed on Oct. 5, 2004, which claims priority to German Application No. 103 46 343.7 filed Oct. 6, 2003, the disclosures of which are incorporated by reference herein.

### BACKGROUND AND SUMMARY OF THE INVENTION

The present invention relates to a brake disc, which may be fastened to a wheel hub, in particular of a commercial vehicle. The brake disc has two concentric friction rings and a brake disc neck.

Brake discs of such type are used, for example, in so-called fixed-caliper brakes, in which the brake disc is embodied as a sliding disc, which is mounted so as to be axially displaceable on the wheel hub or on a wheel axle.

During braking, the brake disc is pressed by a first brake shoe against an opposing second brake shoe, the respective contact faces of the brake disc being formed by the friction rings.

In order to compensate for the working stroke, which results, during each braking operation, from the air gap in the brakes which must be overcome, and for the elastic deformation of the brake linings and of the brake caliper, which occurs as force is applied, a brake disc is known from DE 101 48 681 A1 which is fastened to the wheel hub or wheel axle by an axially deflectable elastic connecting part. As a result, it is possible to dispense with previously conventional slide guides, by which the brake disc was held in an axially moveable manner, corresponding to the working stroke, on the wheel hub. The long-term operational reliability of the slide guides was restricted, in particular on account of, for example, dirt accumulation during operation.

The brake disc known from DE 101 48 681 A1 has proven itself in principle. However, the connecting part which is used here is formed in such a way that it can be connected to the brake disc only in the region of the friction rings. A desired application in a brake disc having a brake disc neck has not been possible with the known design.

The present invention is, therefore, based on further developing a brake disc of the above-mentioned type such that its service life is improved.

According to an aspect of the invention, the brake disc neck is fastened to the wheel hub by way of a connecting part, which connecting part is fixedly attached to the brake disc neck and may be elastically deformed axially relative to the friction rings.

The brake disc neck/friction rings structural unit is now axially moveable, corresponding to the required working stroke, without the need for guide elements, for example in the form of tongues and grooves as described in the prior art, for this purpose.

The connecting part is preferably formed as an annular spring element, which extends in the radial direction and is, therefore, capable of absorbing correspondingly acting forces.

This likewise applies to the fastening of the connecting part to the brake disc neck, which fastening is preferably positive and/or non-positive, the fastening being formed such that it is capable of absorbing torques acting on the friction rings during braking.

It is an advantage of the invention that it can be realized using simple design means, resulting not only in production being cost-effective, but also in practically fault-free operation.

The connecting element, which is formed as an annular spring element and completely surrounds the brake disc neck, is made from a material which permits long-term operation. This means that there are no spares costs and repair costs compared to the prior art when using the connecting part. The operational reliability of the brake disc is, therefore, likewise improved since wear-related operational faults are practically no longer possible.

The axial deformation behavior of the connecting part may be influenced by way of corresponding shaping.

Integrally formed corrugations, which run in a continuously or partially encircling manner on the spring element, are thus contemplated. As a result, a reduction in deformation forces in the axial direction is also obtainable, such as by the use of apertures which form a material weakening and, therefore, influence the shape behavior of the spring element.

The danger of radial deformation of the spring element as a result of torsional forces occurring during braking can be counteracted by providing an additional spring element, which is fixedly connected, together with the first spring element, to the wheel hub or wheel axle.

The torsional force absorption and thus the load on each spring element is varied as a function of the spacing between the two spring elements and/or of the spacing between the friction rings and the spring element which faces the latter.

High stability is also obtained if a spring element is likewise arranged in the interior of the brake disc neck, preferably in one plane with the friction rings. The spring element may rest in the wheel axle guided in the brake disc neck or may be connected to the wheel axle there. To reduce the axial deformation forces, that is to say to influence the spring force while simultaneously optimizing weight, the inner spring element may likewise be provided with corrugations or the like which are, for example, formed by material folds.

According to a further consideration of the invention, the connecting part, which is fastened to the outside of the brake disc neck, is provided with a cylindrical attachment which is connected to the brake disc neck and in a sense forms its extension.

A desired reduction in the axial deformation forces with simultaneously higher torque transmission can also be achieved when, in the connecting region to the brake disc neck, the outer and/or inner spring element has radially running tongues which are formed by recesses and engage in the brake disc neck in a positive and/or non-positive manner.

The arrangement of a plurality of spring elements, preferably two arranged in parallel and with a spacing to one another, additionally leads to effective counteraction of so-called wobbling of the brake disc, as can occur as a result of the torsional forces during braking.

In order to minimize warping of a brake disc without a brake disc neck, another embodiment provides two spring elements which are connected directly to the friction rings. The two spring elements are arranged in the plane of the brake disc with a spacing to one another and are connected to the wheel hub or wheel axle.

The spring elements may also be provided with corrugations in the form of folds or with recesses, one or both spring elements being correspondingly formed depending on requirements, in order to reduce the axial deformation forces.

Further advantageous embodiments of the inventions are described and claimed herein.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a novel brake disc according to the invention in a perspective view;

FIGS. 2-11 show various exemplary embodiments of the brake disc in FIG. 1 in a longitudinal section or rear view (FIG. 8);

FIG. 12 shows a further exemplary embodiment of the brake disc according to the invention in a perspective view; and

FIG. 13 shows a brake disc according to another embodiment of the invention in a cross-sectioned view.

### DETAILED DESCRIPTION OF THE DRAWINGS

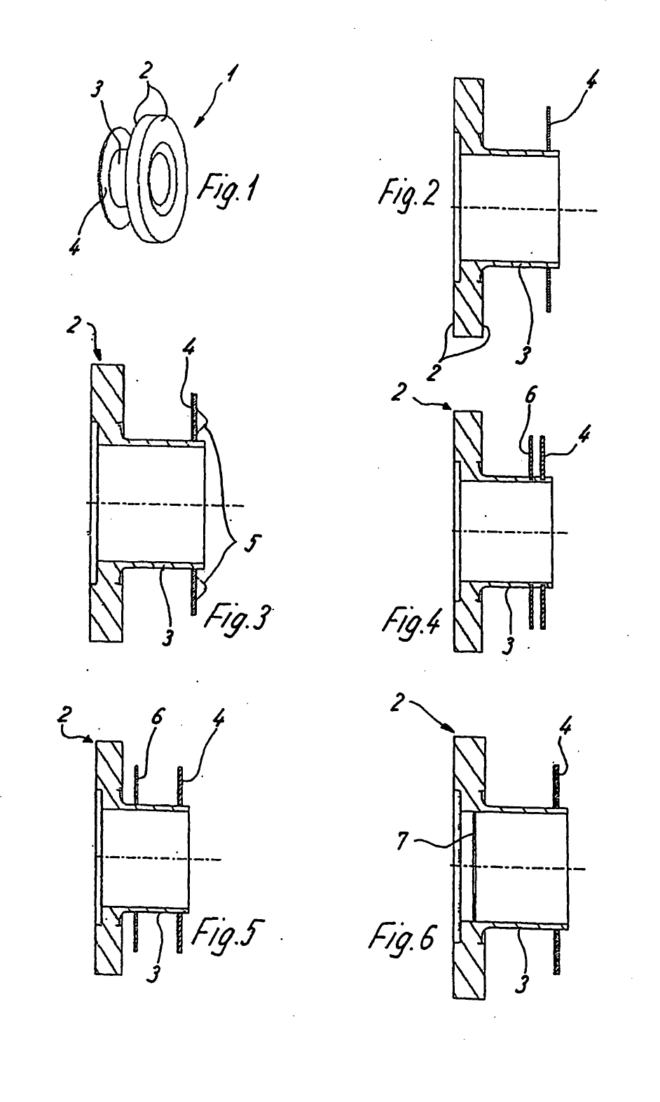

FIGS. 1 through 12 illustrate a brake disc 1 for a disc brake, which brake disc 1 is fastenable to a wheel hub, in particular of a commercial vehicle. The brake disc has two concentric friction rings 2 which form the friction faces for brake pads (which are not illustrated) of the disc brake. The brake pads are provided with friction linings and may be pressed on the friction surfaces of the friction rings.

In addition, the brake disc 1 has a coaxial brake disc neck 3, in which a wheel axle of the vehicle can be guided.

A connecting part in the form of an annular spring element 4 is fixedly attached in a free end region, that is to say the end region which faces away from the friction rings 2, and is fastened to a wheel hub or the wheel axle.

The spring element 4 is elastically deformable axially relative to the friction rings 2, specifically to the extent defined by the working stroke of the disc brake

The spring element 4, which is otherwise arranged parallel to the friction rings 2, is preferably connected in a positive manner to the brake disc neck 3. A non-positive or cohesive connection is however also possible.

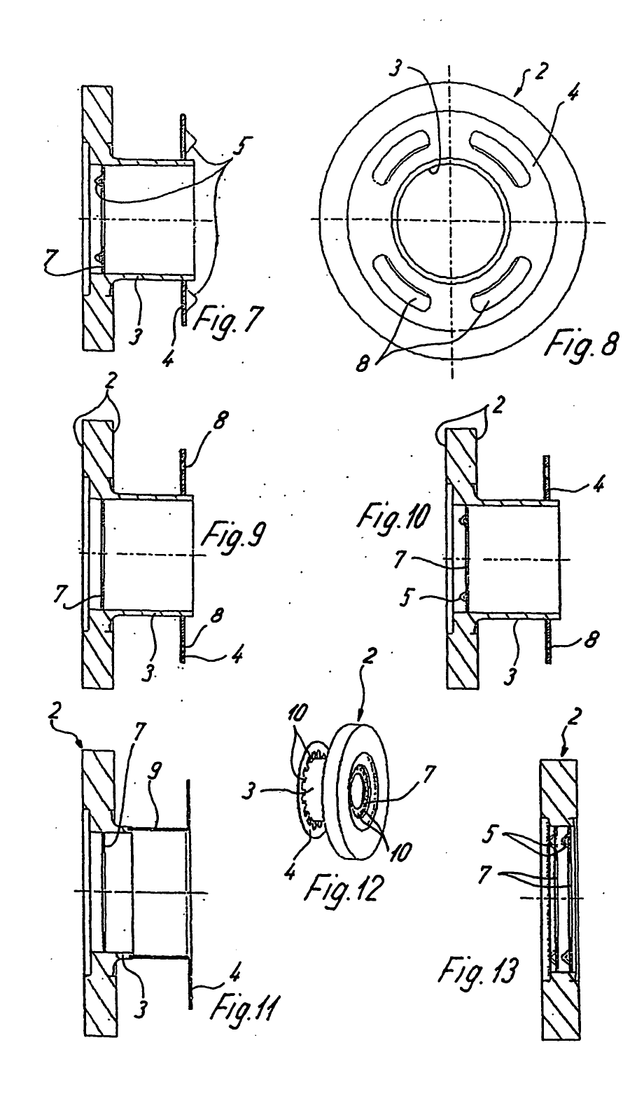

In the exemplary embodiment shown in FIG. 3, corrugations in the form of folds 5, by which the axial deformation forces are reduced, are provided on the surface of the spring element 4.

In order to increase the radial moment of resistance, and for an associated minimization of the radial deformation of the spring element 4, a second spring element 6 is fastened to the brake disc neck 3 parallel to the first spring element 4, as can be seen in FIGS. 4 and 5.

While, for example, in FIG. 4, the two spring elements 4, 6 are arranged with a small spacing to one another, the spacing between the spring elements 4, 6 in the example illustrated in FIG. 5 is larger, resulting in an overall increase in stability.

Such an increase in stability may also be obtained by use of a second spring element 7 which, as shown in FIG. 6, is fastened to an inner wall of the brake disc neck 3, specifically in approximately the plane of the friction rings 2, that is to say in that end region of the brake disc neck 3 which faces away from the spring element 4.

In addition to the first spring element 4, the inner, second spring element 7 may also be provided with corrugations in the form of the folds 5, which are preferably situated on one side of the annular face, in order to reduce the axial deformation forces (see FIG. 7).

Instead of the folds 5, the one spring element or both spring elements 4, 6 may be provided with recesses 8, as can be seen in FIG. 8, in order to reduce the axial deformation forces. Here, the recesses 8 are arranged concentrically and preferably with equal angular spacing to one another.

With this design, in addition to the mentioned reduction in the axial deformation forces, the braking torque (radial and axial) may also be transmitted without appreciable deformation.

In FIG. 9, it can be seen that the first spring element 4, which is fastened to the outside of the brake disc neck 3, is provided with the recesses 8, while the second spring element 7 is fastened in the interior of the brake disc neck 3.

A combination of the presented possibilities for reducing the axial deformation forces may be gathered from FIG. 10, the outer spring element 4 having the recesses 8, while the inner spring element is provided with folds 5. At the same time, the inner spring element 7 ensures high stability, in particular with regard to overall deformation of the brake disc 1, which can lead in some circumstances to the previously mentioned wobbling during braking.

FIG. 12 illustrates a further embodiment of the spring elements 4, 7 which are provided, in the connecting region to the brake disc neck 3, with tongues 10 which are arranged with an equal spacing to one another all the way around. By way of each of the tongues 10 the connection to the brake disc neck 3 is formed. The free spaces formed between the tongues 10 result in material weakening which, although bringing about a reduction in the axial deformation resistance, simultaneously ensures high torque transmission.

The brake disc 1 shown in FIG. 11 has a brake disc neck 3 which is shorter than that of the examples already described, as an extension of which brake disc neck 3 is attached a pipe section 9 which bears the spring element 4 and is formed in one piece with the spring element 4.

A brake disc can be seen in FIG. 13 which has no disc neck, but rather in which two connecting parts in the form of the spring elements 7 are directly connected to the friction rings 2. Here, the spring elements 7 are arranged in parallel and with a spacing with respect to one another, transversely with respect to the central axis of the brake disc 1, and can be fastened to a wheel hub or wheel axle.

The connection of two inner spring elements 7 leads to a reduction in brake disc warping as can result from the braking torques which occur. In a manner already described, the spring elements 7 are also provided here with folds 5, by which the axial deformation resistance is reduced.

Table of reference symbols

| | |
|---|---|
| 1 | Brake disc |
| 2 | Friction ring |
| 3 | Brake disc neck |
| 4 | Spring element |
| 5 | Fold ring |
| 6 | Spring element |
| 7 | Spring element |
| 8 | Recess |
| 9 | Pipe section |
| 10 | Tongue |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake disc for a disc brake, the brake disc being fastenable to a wheel hub, the brake disc comprising:
two concentric friction rings;
a brake disc neck operatively connected to the two concentric friction rings;
a connecting part fixedly attached to the brake disc neck, the connecting part fastening the brake disc neck to the wheel hub; and
wherein the connecting part is elastically deformable axially relative to the two friction rings.

2. The brake disc according to claim 1, wherein the connecting part comprises an annular spring element.

3. The brake disc according to claim 2, further comprising a second spring element fastened to the brake disc neck in parallel with, and spaced apart from, the annular spring element.

4. The brake disc according to claim 2, further comprising a further spring element arranged in an interior space formed by the brake disc neck.

5. The brake disc according to claim 4, wherein the further spring element is arranged approximately in a plane of the two friction rings and transversely with respect to a central axis of the brake disc.

6. The brake disc according to claim 2, wherein the annular spring element includes corrugations forming folds in order to reduce an axial deformation resistance.

7. The brake disc according to claim 3, wherein the second spring element includes corrugations forming folds in order to reduce an axial deformation resistance.

8. The brake disc according to claim 4, wherein the further spring element includes corrugations forming folds in order to reduce an axial deformation resistance.

9. The brake disc according to claim 6, wherein the folds are concentrically distributed over a base face of the annular spring element.

10. The brake disc according to claim 7, wherein the folds are concentrically distributed over a base face of the second spring element.

11. The brake disc according to claim 8, wherein the folds are concentrically distributed over a base face of the further spring element.

12. The brake disc according to claim 3, wherein at least one of the spring elements is provided with recesses, which recesses are concentrically and uniformly distributed over a base face of the spring elements to reduce an axial deformation resistance.

13. The brake disc according to claim 4, wherein at least one of the spring elements is provided with recesses, which recesses are concentrically and uniformly distributed over a base face of the spring elements to reduce axial deformation resistance.

14. The brake disc according to claim 12, wherein one of the spring elements is provided with the recesses and another of the spring elements is provided with folds.

15. The brake disc according to claim 13, wherein one of the spring elements is provided with the recesses and another of the spring elements is provided with folds.

16. The brake disc according to claim 3, wherein at least one spring element is fastened by way of tongues to the brake disc neck.

17. The brake disc according to claim 16, wherein the tongues extend in a radial direction and are equally spaced apart with respect to one another.

18. The brake disc according to claim 3, wherein at least one of the spring elements is fastened in a positive, non-positive, or cohesive manner to the brake disc neck.

19. A brake disc for a disc brake, the brake disc being fastenable to a wheel hub or wheel axle of a commercial vehicle, the brake disc comprising:
two concentric friction rings;
a connecting part operatively fastened to the two friction rings, the connecting part connecting the two friction rings with the wheel hub or wheel axle;
wherein the connecting part comprises at least two spring elements which are arranged in parallel and spaced apart from one another, the at least two spring elements being elastically deformed axially relative to the two friction rings.

20. The brake disc according to claim 19, wherein at least one spring element comprises one of folds and recesses in order to reduce axial deformation resistance.
